(19) United States
(12) Patent Application Publication
(10) Pub. No.: US 2011/0087965 A1
(43) Pub. Date: Apr. 14, 2011

(54) METHOD FOR SETTING UP A LIST OF AUDIO FILES FOR A MOBILE DEVICE

(75) Inventors: Bjorn Patrick Johansson, Alpharetta, GA (US); Michael Maddux, Dunwoody, GA (US)

(73) Assignee: SONY ERICSSON MOBILE COMMUNICATIONS AB, Lund (SE)

(21) Appl. No.: 12/578,705

(22) Filed: Oct. 14, 2009

(51) Int. Cl. G06F 3/16

(52) U.S. Cl. 715/727

(57) ABSTRACT

A method for setting up a list of audio files for a mobile device, and a mobile device utilizing the method for setting up the list of audio files are described.

### BACKGROUND OF THE INVENTION

The present invention relates to a method for setting up a list of audio files for a mobile device, and a mobile device utilizing the method for setting up the list of audio files.

### BRIEF SUMMARY OF THE INVENTION

According to an embodiment, a method for setting up a list of audio files for a mobile device is provided. The mobile device is adapted to play back audio data of the audio files. According to the method, a content of at least one user preferred audio file is determined. The content of the at least one user preferred audio file is compared with a content of a plurality of audio files. Based on this comparison for each audio file of the plurality of audio files a similarity between the content of this audio file of the plurality of audio files and the content of the at least one user preferred audio file is defined. The audio file of the plurality of audio files with the largest similarity is added to the list of audio files.

An audio file of the plurality of audio files may represent a music file of a song having lyrics and the at least one user preferred audio file may also represent a music file of a song with lyrics. The lyrics may represent the content of the corresponding audio file.

The at least one user preferred audio file may be an audio file which is currently played back by the mobile device or an audio file of a so called favorite list stored in the mobile device.

According to an embodiment, the plurality of audio files is stored in the mobile device and a content of the plurality of audio files is determined to be compared with the content of the at least one user preferred audio file. Additionally or as an alternative, the plurality of audio files may be stored on a server the mobile device may communicate with. A content of the plurality of audio files on the server is also determined for a comparison with the content of the at least one user preferred audio file.

A user of a mobile device listening to audio files being played back by the mobile device typically has audio files stored on the mobile device which the user likes. By generating a list of audio files as defined according to the method above, a new list of audio files, a so-called play list, is generated based on the users preferences. Therefore, the user seamlessly gets exposed to new content with similar content or lyrics to the one the user already likes. Therefore, the user will be able to listen to similar songs based on the best-liked content or audio files.

According to an embodiment, when adding the audio file of the plurality of audio files with the largest similarity to the list of audio files, only those audio files of the plurality of audio files are added, which have the largest or a large similarity and are currently not contained in the list of audio files and do not correspond to the at least one user preferred audio file. This may avoid duplicate audio files in the list of audio files and an already existing favorite list of the user.

According to another embodiment, upon adding the audio file of the plurality of audio files with the largest similarity to the list of audio files, audio data of the audio file is transferred from the server to the mobile device. This enables the user to directly play back audio data of audio files which have been added to the list of audio files.

According to an embodiment, when comparing the content of the at least one user preferred audio file with the content of the plurality of audio files, a first list of keywords is set up based on the content of the at least one user preferred audio file, and a plurality of second lists of keywords is set up based on the content of the plurality of audio files, wherein one of the plurality of second keyword lists comprises keywords of the content of one associated audio file of the plurality of audio files. The similarity for each audio file of the plurality of audio files is defined based on a matching between the first list of keywords and the corresponding second list of keywords.

According to yet another embodiment, when comparing the content of the at least one user preferred audio file with the content of the plurality of audio files, a first theme is determined based on the content of the at least one user preferred audio file and a plurality of second themes is determined based on the content of the plurality of audio files, wherein one of the plurality of second themes is determined based on the content of the one of the plurality of audio files. The similarity for each audio file of the plurality of audio files is defined based on a matching between the first theme and the corresponding second theme.

According to an embodiment, a mobile device is provided. The mobile device comprises a processing unit. The processing unit is adapted to determine a content of the at least one user preferred audio file and to compare the content the at least one user preferred audio file with a content of a plurality of audio files to define for each audio file of the plurality of audio files a similarity between the content of the audio file of the plurality of audio files and the content of the at least one user preferred audio file. The processing unit is further adapted to add the audio file of the plurality of audio files with the largest similarity to a list of audio files.

According to an embodiment, the mobile device may be a mobile phone, a personal digital assistant, a mobile navigation system, a mobile music player, like an MP3 player, or a mobile computer.

Although specific features described in the above summary and in the following detailed description are described in connection with specific embodiments, it is to be understood that the features of the embodiments described can be combined with each other unless it is noted otherwise.

### BRIEF DESCRIPTION OF THE DRAWINGS

Hereinafter, exemplary embodiments of the invention will be described with reference to the drawings.

FIG. 1 shows schematically a mobile device according to an embodiment of the present invention.

FIG. 2 shows a flow chart of a method according to an embodiment of the present invention.

### DETAILED DESCRIPTION OF THE INVENTION

In the following, exemplary embodiments of the present invention will be described in detail. It is to be understood that the following description is given only for the purpose of illustrating the principles of the invention and is not to be taken in a limiting sense. Rather, the scope of the invention is defined only by the appended claims and not intended to be limited by the exemplary embodiments hereinafter.

It is to be understood that the features of the various exemplary embodiments described herein may be combined with each other unless specifically noted otherwise.

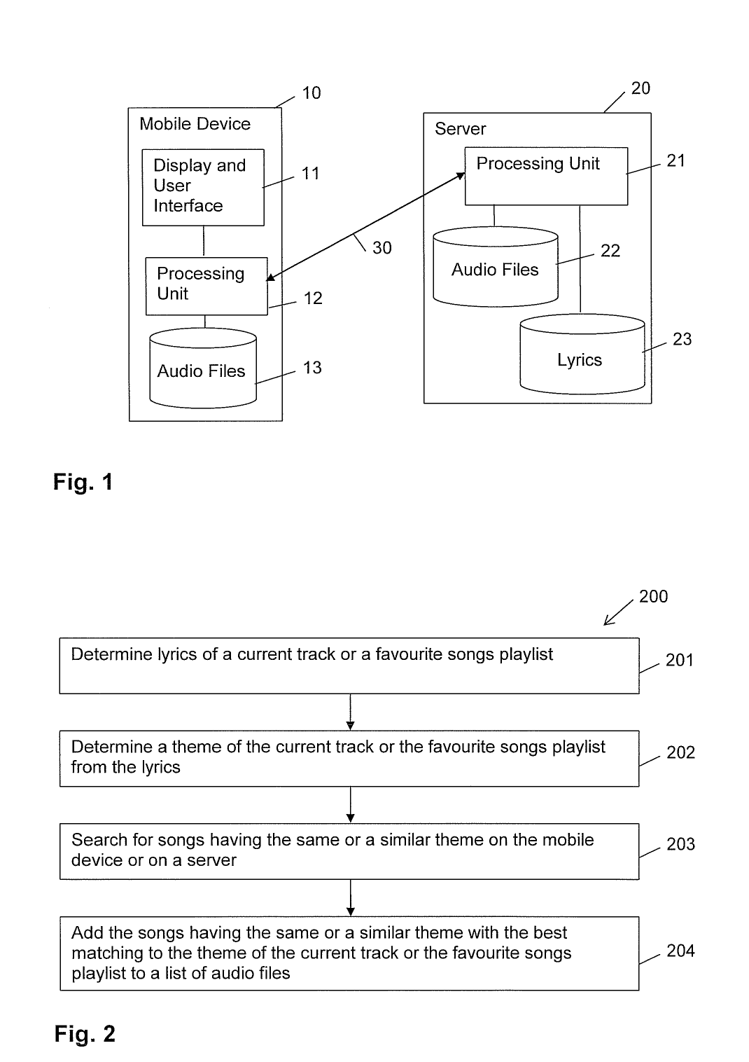

FIG. 1 shows schematically a mobile device 10 which may be connected to a server 20 via a connection 30. The connection 30 may be a wireless connection, for example an GSM, UMTS, GPRS or Bluetooth connection. However, connection 30 may be any other kind of wireless or wired connection.

The mobile device 10 comprises a display and user interface 11, a processing unit 12 and a memory 13. The processing unit 12 is connected to the display and user interface 11 and to the memory 13. In the memory 13 audio files may be stored which may be played back by the mobile device 10.

The server 20 comprises a processing unit 21, a memory for audio files 22 and a memory for lyrics 23. In the lyrics memory 23 are stored lyrics of each of the audio files stored in the audio files memory 22 and maybe additional lyrics of audio files which are currently not stored in the audio files memory 22. For example the lyrics memory 23 may also comprise lyrics of the audio files stored in the memory 13 of the mobile device 10. However, although in FIG. 1 the server comprises a memory 22 for the audio files and a memory 23 for the lyrics, the server 20 may represent different kinds of server, for example a server which provides audio files only, a server which provides lyrics only, and/or a server which provides audio files and lyrics. Therefore, the server 20 shown in FIG. 1 may represent several servers provided in a data communication network, for example provided in the internet. Furthermore, the server 20 may be a customer premises server, for example a personal computer. The server 20 may also be a so called DLNA-server which is compatible to the digital living network alliance (DLNA) standard used by manufacturers of consumer electronics to allow entertainment devices within the home to share their content with each other across a home network.

Upon a user request input via the display and user interface 11 the processing unit 12 of the mobile device 10 may be started to create a list of audio files with similar lyrics to an audio file which is currently being played back by the mobile device 10 or to audio files of a current play list or a favorite list of the mobile device 10. The user may start the creation of the list of audio files by actuating an icon or menu entry of the user interface 11 of the mobile device 10. Upon starting the creation of the list of audio files the processing unit 12 performs the method steps of the flow chart 200 shown in FIG. 2. Furthermore, there may be predefined or user-defined points in time when a creation of the list of audio files is automatically started.

In step 201 the processing unit 12 determines lyrics of an audio file or a track being currently played back on the mobile device 10, or lyrics of audio files of a favorite list defined in the mobile device 10. It may be configurable by the user whether the current track or audio files of the favorite list shall be used for creating the list of audio files. Alternatively, this may be predefined in the software of the processing unit. The lyrics to be determined may be stored together with the audio files in the memory 13 of the mobile device 10. In this case, the processing unit 12 can access the lyrics directly from the memory 13. However, if the lyrics of the current track or the audio files of the favorite list are not stored in the memory 13 of the mobile device 10, the processing unit 12 may set up a communication connection 30 to the server 20 to retrieve lyrics of the current track or audio files of the favorite list. Retrieving the lyrics may be accomplished by sending a title and the name of the artist of an audio file to the server 20, whereupon the server 20 retrieves the lyrics and transmits the lyrics as a response to the processing unit 12. Furthermore, the processing unit 12 may transmit other characteristics of the audio file to the server 20 to retrieve the lyrics. These characteristics may be for example a part of the audio data which is then recognized in the server and the corresponding lyrics may be retrieved.

Based on the determined lyrics the processing unit 12 determines in step 202 a theme of the current track or the favorite songs list. Determining the theme may comprise an analyzing of the lyrics for example with respect to keywords or phrases which occur more frequently in the lyrics. As an example, themes like “New York”, “holiday” or “summer time” may be determined.

In step 203 songs having the same or a similar theme are searched. This search may be performed on the mobile device 10 itself by retrieving lyrics of other audio files stored in the memory 13 of the mobile device and determining for each of the audio files a corresponding theme. The determined themes of the other audio files is then compared to the theme of the current track or the theme of the favorite list and in this manner a similarity can be defined for each audio file stored in the memory 13. Additionally or as an alternative, the search for songs having the same or a similar theme may be performed on the server 20. Therefore, the mobile device 10 may send the determined theme of the current track or the favorite list to the server 20 and the server 20 searches based on the lyrics stored in the lyrics memory 23 for songs having the same or a similar theme. As a result the server 20 may transmit a list of audio files having the same or a similar theme back to the processing unit 12 of the mobile device 10.

Based on the search result, the processing unit 12 adds in step 204 the songs having the same or a similar theme with the best matching to the theme of the current track or the favorite list to the list of audio files. The number of songs being added to the list of audio files may be predefined or may be configurable by the user of the mobile device 10. However, to avoid that songs being added to the list of audio files twice or more as the song was e.g. found at several sources, only those songs may be added to the list of audio files that are so far not part of the list of audio files. When a song is added to the list of audio files, only a reference or a pointer to the audio file, i.e. the audio data, of the song may be added to the list of audio files. Furthermore, several lists of audio files may be created, and one song may be part of one or more of the several lists of audio files. If one song is part of two or more lists of audio files, the audio file of this song may be stored only once in the memory 13 and a reference or pointer to the audio file of this song may be stored in each of the two or more lists of audio files.

In a further (not shown) step the processing unit 12 may download automatically or after having prompted the user for purchase the audio files corresponding to the songs being added to the list of audio files from the server 20 to the memory 13 of the mobile device 10. Thus, the user can play back the audio files shown in the newly created list of audio files.

The above-described mobile device enables the user to generate play lists with content based on the lyrics from some already known content. The play lists may be created either by matching similar local content or by querying a service provider, for example TrackID, PlayNow, Napster and so on based on the content of the song. Therefore, seamlessly the user gets exposed to new content with similar content or lyrics to the one the user already likes. Using an external service, for example the server 20 in FIG. 1, provides an access to a nearly infinite data base of content.

While exemplary embodiments have been described above, various modifications may be implemented in other embodiments. For example, instead of creating the list of audio files based on a theme of the current track or the favorite list compared with themes of further audio files of the mobile device or the server, a first keyword list determined from the current track or the favorite list and a plurality of second keyword lists based on lyrics from the audio files of the server may be compared to define a similarity between the currently played track or the songs of the favorite list and the audio files of the server.

Finally, it is to be understood that all the embodiments described above are considered to be comprised by the present invention as it is defined by the appended claims.

What is claimed is:

1. A method for setting up a list of audio files for a mobile device, the mobile device being adapted to play back audio data of the audio files, the method comprising:
determining a content of at least one user preferred audio file,
comparing the content of at least one user preferred audio file with a content of a plurality of audio files to define for each audio file of the plurality of audio files a similarity between the content of the audio file of the plurality of audio files and the content of the at least one user preferred audio file, and
adding the audio file of the plurality of audio files with the largest similarity to the list of audio files.

2. The method according to claim 1, wherein an audio file of the plurality of audio files and the at least one user preferred audio file represents a song having lyrics, wherein the lyrics represents the content of the audio file.

3. The method according to claim 1, wherein the step of adding the audio file of the plurality of audio files with the largest similarity to the list of audio files comprises
adding the audio file of the plurality of audio files with the largest similarity to the list of audio files which is currently not contained in the list of audio files and which does not correspond to the at least one user preferred audio file.

4. The method according to claim 1, wherein the at least one user preferred audio file is a audio file which is currently played back by the mobile device.

5. The method according to claim 1, wherein the plurality of audio files is stored in the mobile device and wherein the method further comprises:
determining a content of the plurality of audio files.

6. The method according to claim 1, wherein the plurality of audio files is stored on a server and wherein the method further comprises:
determining a content of the plurality of audio files.

7. The method according to claim 6, wherein upon adding the audio file of the plurality of audio files with the largest similarity to the list of audio files, audio data of the audio file is transferred from the server to the mobile device.

8. The method according to claim 1, wherein comparing the content of the at least one user preferred audio file with the content of the plurality of audio files comprises:
setting up a first list of keywords based on the content of the at least one user preferred audio file,
setting up a plurality of second lists of keywords based on the content of the plurality of audio files, one of the plurality of second keyword lists comprising keywords of the content of one of the plurality of audio files, and
defining the similarity for each audio file of the plurality of audio files based on a matching between the first list of keywords and the corresponding second list of keywords.

9. The method according to claim 1, wherein comparing the content of the at least one user preferred audio file with the content of the plurality of audio files comprises:
determining a first theme based on the content of the at least one user preferred audio file,
determining a plurality of second themes based on the content of the plurality of audio files, one of the plurality of second themes being determined based on the content of one of the plurality of audio files, and
defining the similarity for each audio file of the plurality of audio files based on a matching between the first theme and the corresponding second theme.

10. A mobile device, comprising
a processing unit adapted
to determine a content of the at least one user preferred audio file,
to compare the content of the at least one user preferred audio file with a content of a plurality of audio files to define for each audio file of the plurality of audio files a similarity between the content of the audio file of the plurality of audio files and the content of the at least one user preferred audio file, and
to add the audio file of the plurality of audio files with the largest similarity to a list of audio files.

11. The mobile device according to claim 10, wherein the mobile device comprises a device selected from the group comprising a mobile phone, a personal digital assistant, a mobile navigation system, a mobile music player and a mobile computer.
